(19) United States
(12) Patent Application Publication
(10) Pub. No.: US 2008/0266195 A1
(43) Pub. Date: Oct. 30, 2008

(54) Waveguide Slot Array Antenna Assembly

(76) Inventors: Satoshi Yamaguchi, Tokyo (JP); Kazushi Nishizawa, Tokyo (JP); Hiroaki Miyashita, Tokyo (JP); Shigeo Udagawa, Tokyo (JP)

Correspondence Address: BIRCH STEWART KOLASCH & BIRCH, PO BOX 747, FALLS CHURCH, VA, 22040-0747, US

(21) Appl. No.: 11/884,132

(22) PCT Filed: Mar. 3, 2005
(86) PCT No.: PCT/JP2005/003603

§ 371 Date: Aug. 10, 2007

(51) Int. Cl. H01Q 13/10

(52) U.S. Cl. 343/771

(57) ABSTRACT

To suppress a standing wave ratio within a waveguide to a lower value, and suppresses a grating lobe, the present invention provides a waveguide slot array antenna device, including a plurality of rectangular slots (2, 3) that are inclined by a given angle with respect to an axis of a rectangular waveguide (1) and are arranged on a wide surface of the rectangular waveguide (1) alternately at opposite positions with respect to a center line that extends along the axial direction of the wide surface of the rectangular waveguide at intervals of ½ wavelength in the waveguide, respectively, in which the respective slots on the same side with respect to the center line are identical with each other in length, width, and distance from the center line, and the slots on opposite sides with respect to the center line are different from each other in at least any one of the length, the width, and the distance from the center line.

### TECHNICAL FIELD

The present invention relates to a waveguide slot array antenna device, and more particularly to a waveguide slot array antenna device having polarized waves in a direction oblique to the axis of a waveguide.

### BACKGROUND ART

In an electric wave radar device (hereinafter referred to as “in-vehicle radar”) which is mounted on a front or a side of a vehicle, detects a leading vehicle, an oncoming vehicle, or an obstacle, and is used to prevent a collision with those objects, the use of a 45-degree oblique polarized wave is effective in preventing an interference with an electric wave issued by the oncoming vehicle. This is because, since the electric wave issued by a subject vehicle and the electric wave issued by the oncoming vehicle are orthogonal to each other, misconception of the respective electric waves can be avoided.

In the in-vehicle radar, it is assumed that a millimeter band, in particular, 76 GHz band is used. In the millimeter band as compared with a microwave band, the conductor loss of an antenna is greatly increased, and in a case of using a dielectric material, since the dielectric loss is greatly increased, an antenna having the loss as low as possible is required to extend a detectable range.

As the antenna that is low in loss even if the millimeter band is used, there is known a waveguide slot array antenna for the 45-degree oblique polarized wave (refer to Non-patent Document 1).

Non-patent Document 1 discloses two kinds of feeding methods including “traveling wave feed” that excites one end of a waveguide and sets another end thereof as reflection-free termination, and “standing wave feed” that short-circuits another end to produce standing waves within the waveguide. The document discloses that in the “traveling wave feed”, a grating lobe level is high, but the grating lobe level can be reduced by conducting the “standing wave feed”.

Non-patent Document 1: Sembon, Koshio, and Goto, “A Slotted Waveguide Array Antenna of 45 Degree Polarization, General Conference of The Institute of Electronics, Information and Communication Engineers, B-1-178, 1998

### DISCLOSURE OF THE INVENTION

### Problem to be Solved by the Invention

In the conventional waveguide slot array antenna device, it is necessary to increase the standing wave ratio within the waveguide in order to suppress the grating lobe. For that reason, there arises such a problem that matching with a feeder of a waveguide 1 is difficult.

Also, since the radiant quantity toward a space is resultantly reduced because the reflectivity is large, there arises such a problem that gain of the antenna is deteriorated, and the detectable range is shortened when the antenna is used in the in-vehicle radar.

On the other hand, in the case of the traveling wave feed, the standing wave ratio is 1. However, there arises such a problem that the grating lobe level increases.

The present invention has been made to solve the above-mentioned problems, and therefore it is an object of the present invention to provide a waveguide slot array antenna device that has a polarized wave in a direction oblique to an axis of a waveguide, and is capable of suppressing the standing wave ratio within the waveguide to a lower value, and suppressing the grating lobe.

### Means for Solving the Problems

A waveguide slot array antenna device according to the present invention is a waveguide slot array antenna device including a plurality of rectangular slots that are inclined by a given angle with respect to an axis of a rectangular waveguide and are arranged on a wide surface of the rectangular waveguide alternately at opposite positions with respect to a center line that extends along the axial direction of the wide surface of the rectangular waveguide at intervals of ½ wavelength in the waveguide, respectively, in which the respective slots on the same side with respect to the center line are identical with each other in length, width, and distance from the center line, and the slots on opposite sides with respect to the center line are different from each other in at least any one of the length, the width, and the distance from the center line.

### EFFECTS OF THE INVENTION

According to the present invention, it is possible to improve the reflection at a feeding point and suppress a wide-angle grating lobe.

### BRIEF DESCRIPTION OF THE DRAWINGS

FIG. 1 is a schematic structural diagram schematically illustrating a waveguide slot array antenna device according to a first embodiment of the present invention.

FIG. 2 is a diagram illustrating a numeric calculation example of a frequency characteristic of a return loss at a feeding point (a solid line indicates a result of the present invention, and a broken line indicates a result of the conventional example).

FIG. 3 is a perspective view illustrating a waveguide slot array antenna device according to a second embodiment of the present invention.

FIG. 4 is a front view of FIG. 3.

### BEST MODE FOR CARRYING OUT THE INVENTION

### First Embodiment

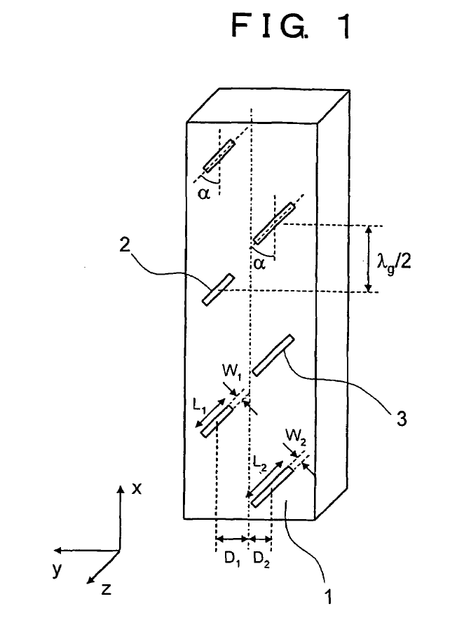

FIG. 1 is a schematic structural diagram schematically illustrating a waveguide slot array antenna device according to a first embodiment of the present invention. Referring to FIG. 1, for convenience, it is assumed that an axial direction of a rectangular waveguide 1 is referred to as x-direction, a direction orthogonal to the axial direction x of the waveguide 1 on a plane on which a rectangular slot 2 is formed is referred to as y-direction, and a direction normal to the plane on which the rectangular slot 2 is formed is referred to as z-direction.

The waveguide slot array antenna device shown in FIG. 1 is a waveguide slot array antenna in which a plurality of rectangular slots 2 and a plurality of rectangular slots 3 are inclined by a given angle α with respect to an axis of the rectangular waveguide 1, and are arranged alternately at opposite positions with respect to a center line that extends along the axial direction of a wide surface of the rectangular waveguide 1 at intervals of ½ wavelength in the waveguide (λg/2, λg: the wavelength in the waveguide), respectively. It is assumed that each of the slots 2 has a length of L1, a width of W1, and a distance of D1 from the center line of the waveguide wide surface. Also, it is assumed that each of the slots 3 has a length of L2, a width of W2, and a distance of D2 from the center line of the waveguide wide surface.

The slots 2 and 3 are different from each other in at least any one of the lengths L1 and L2, the widths W1 and W2, and the distances D1 and D2 from the center line of waveguide wide surface. In addition, the slots on the same side with respect to the center line of the waveguide 1 are identical with each other. In other words, referring to FIG. 1, all of the slots on the left side (+y direction side) with respect to the center line of the waveguide wide are the slots 2, and all of the slots on the right side (−y direction side) with respect to the center line of the waveguide wide are the slots 3.

Subsequently, effects of the present invention will be described. When a parameter such as the length or the width of the slots, or the distance from the center line of the waveguide wide surface changes, it is possible to change the magnetic field and the degree of coupling of the slots within the waveguide 1. Hence, the reflection component from the slots or the amplitude and phase of the component which is radiated toward the space from the slot change within the waveguide 1. Accordingly, the parameters of the two adjacent slots 2 and 3 are adjusted, thereby making it possible to select the combination that is low in reflection within the waveguide 1 and large in radiant quantity toward the space.

The radiation pattern of the single slot has a configuration that has a non-directional property on an electric field plane (E plane), and has a radiation reduced in a wide-angle direction on a magnetic field plane (H plane). For that reason, in the waveguide slot array antenna having the slots inclined obliquely with respect to the axis of the waveguide 1, the components that are coupled together through the space have such features that the coupling between the slots which have the positional relationship in the E plane direction is strong, and the coupling between the slots which have the positional relationship in the H plane direction is weak. Accordingly, in the case where an influence of the components that are coupled together through the space is taken into consideration, attention is paid to the slots 2 and the slots 3 which particularly have the positional relationship in the E plane direction to adjust the parameters.

Also, in the present invention, since the respective slots 2 and slots 3 are arranged at the intervals of one wavelength within the waveguide on the same side with respect to the center line of the waveguide 1, respectively, the amplitudes and the phases of electronic waves which are radiated from the respective slots 2 or the respective slots 3 are identical with each other. Accordingly, when the excitation distribution of the slots 2 and the slots 3 are made uniform, the uniform excitation distribution can be obtained as the entire array antenna.

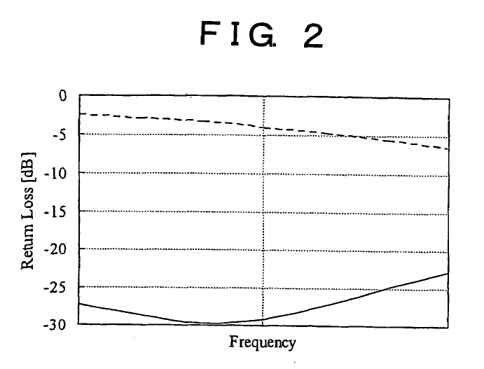

As one example of the effects obtained by the present invention, a numeric calculation example of the frequency characteristic of a return loss at the feeding point is shown in FIG. 2. The calculation is conducted by using a finite element method. A solid line shown in FIG. 2 indicates the results of the present invention, and a broken line indicates the results of the conventional example. As shown in FIG. 2, it is understood that sufficiently low reflection characteristics are obtained by the present invention.

### Second Embodiment

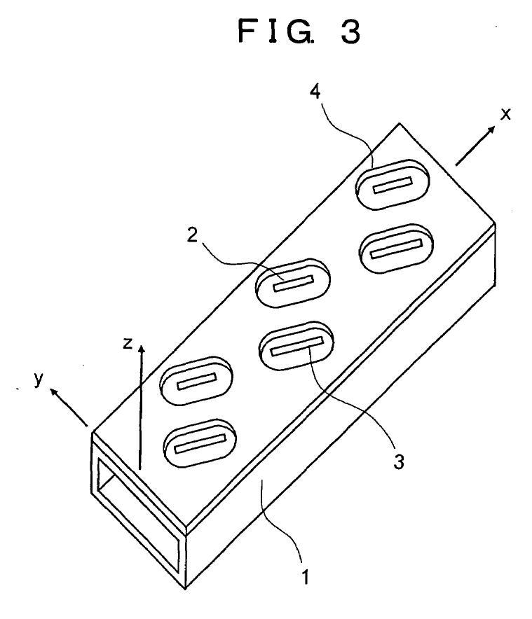

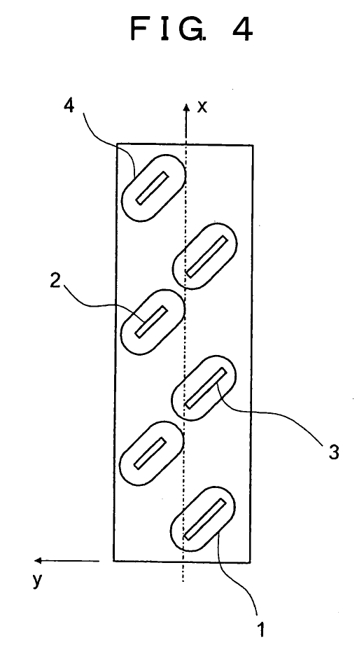

FIG. 3 is a perspective view showing a waveguide slot array antenna device according to a second embodiment of the present invention. Further, FIG. 4 shows a front view of FIG. 3. In FIGS. 3 and 4, metal cylinders 4 having given cross sections and depths are disposed on the upper portions of the slots 2 and 3 so as not to block the slots, respectively.

In the array antenna, there has been known that it is effective, as means for suppressing the grating lobe that is generated in the wide angle direction, to sharpen the directivity and narrow the beam width of the array element pattern of the respective radiation elements. For that reason, the radiation area of the respective radiation elements may be increased.

Under the circumstances, as shown in FIGS. 3 and 4, the metal cylinders 4 are disposed on the upper portions of the slots 2 and 3, thereby making it possible to increase the equivalent radiation area of the respective slots 2 and 3. As a result, it is possible to suppress the grating lobe that is generated in the wide angle direction and improve the antenna gain.

Also, the cross section and thickness of the metal cylinders 4 are adjusted, thereby controlling the gain and beam width of the respective elements.

As a method of disposing the metal cylinders 4, a cut-out metal plate may be covered on the waveguide 1, or the metal plate may be cut integrally with the slots 2 and 3.

The cross section of the metal cylinder 4 may be appropriately selected from a rectangular configuration, a circular configuration, an oval configuration, and the like. Also, the cross section of the metal cylinder 4 may be gradually changed in a step configuration, a tapered configuration, or the like with respect to the z-direction. In addition, the configuration of the metal cylinders 4 may be different between the slots 3 and the slots 4.

### INDUSTRIAL APPLICABILITY

The waveguide slot array antenna according to the present invention improves the reflection at the feeding point and suppresses the wide-angle grating lobe, which is therefore useful as the in-vehicle radar.

1. A waveguide slot array antenna device, comprising a plurality of rectangular slots that are inclined by a given angle with respect to an axis of a rectangular waveguide and are arranged on a wide surface of the rectangular waveguide alternately at opposite positions with respect to a center line that extends along the axial direction of the wide surface of the rectangular waveguide at intervals of ½ wavelength in the waveguide, respectively,
wherein the respective slots on the same side with respect to the center line are identical with each other in length, width, and distance from the center line, and slots on opposite sides with respect to the center line are different from each other in at least any one of the length, the width, and the distance from the center line.

2. The waveguide slot array antenna device according to claim 1, wherein having given cross sections and depths are disposed on upper portions of the slots so that the metal cylinders do not block the slots, respectively.
